(19) United States
(12) Patent Application Publication
(10) Pub. No.: US 2012/0044119 A1
(43) Pub. Date: Feb. 23, 2012

(54) BICONICAL DIPOLE ANTENNA INCLUDING CHOKE ASSEMBLIES AND RELATED METHODS

(75) Inventors: Russell W. Libonati, Melbourne, FL (US); Larry Goldstein, Melbourne, FL (US); Francis Parsche, Palm Bay, FL (US)

(73) Assignee: Harris Corporation, Melbourne, FL (US)

(21) Appl. No.: 12/860,185

(22) Filed: Aug. 20, 2010

(51) Int. Cl. H01Q 9/28; H01Q 17/00

(52) U.S. Cl. 343/807; 29/601

(57) ABSTRACT

An antenna assembly may include first and second adjacent antenna elements each including a conical antenna body having a base and an apex opposite the base. The antenna assembly may also include a cylindrical antenna body extending from the base of the conical antenna body, and a choke assembly including a choke shaft having a proximal end coupled to the conical antenna body and a distal end opposite the proximal end. The choke assembly may include at least one choke member carried by the distal end of the choke shaft in longitudinally spaced relation from an opposing end of the cylindrical antenna body to define at least one choke slot. Each of the first and second conical antenna bodies may be aligned along a common longitudinal axis with respective apexes in opposing relation to define a symmetrical biconical dipole antenna.

### FIELD OF THE INVENTION

The present invention relates to the field of antennas, and, more particularly, to biconical dipole antennas and related methods.

### BACKGROUND OF THE INVENTION

A particular type of antenna may be selected for use in an electronic device based upon a desired application. For example, a different type of antenna may be used for terrestrial communications versus satellite communications. The type of antenna used may also be based upon a desired operating frequency of the antenna.

One example of a type of antenna is a broadband antenna. A broadband antenna is an antenna that operates over a wide range of frequencies. The broadband antenna may be formed to provide increased gain along the horizon, for example, during terrestrial communications.

One type of broadband antenna is a biconical antenna. A biconical antenna has inherent broadband characteristics. However, a diameter of a biconical antenna becomes increasingly large at lower operational frequencies. A larger diameter or size may be restricted in a mobile wireless communications device as the size of the housing carrying the biconical antenna may be limited in size. To reduce the size of the biconical antenna, the biconical antenna may be truncated. As a result, a dipole-type structure is formed.

Increased antenna performance at lower frequencies may correspond to increased antenna length. However, at higher frequencies the increased length may result in the formation of lobes in the antenna pattern, thus resulting in relatively low gain on the horizon.

For example, referring now to the biconical antenna 170 in FIG. 1a, and the graphs in FIGS. 1b-1c, the biconical antenna has relatively satisfactory performance at the horizon both for low (FIG. 1b) and high (FIG. 1c) frequencies. However, the biconical antenna has a relatively large diameter, for example, 15.5″ tall by 15.3″ in diameter, for a desired operating frequency range.

Additionally, referring to the truncated biconical antenna 180 (i.e. dipole with biconical feed) in FIG. 2a, and the graphs in FIGS. 2a-2c, the truncated biconical antenna feed has relatively satisfactory performance at the horizon at low frequencies (FIG. 2b). The dominate dipole structure may be too long for the higher frequencies, which illustratively causes a lobe to form at the horizon (FIG. 2c). Example dimensions for the truncated biconical dipole are 15.5″ tall×4″ in diameter for the desired operating frequency range.

U.S. Pat. No. 7,221,326 to Ida et al. discloses a biconical antenna. More particularly, the biconical antenna includes a columnar dielectric member having frustum-shaped cavities extending respectively from an upper and lower surface toward the center of the columnar member. Flat surfaces of apex portions of the frustum-shaped cavities are parallel and in opposition to one another.

U.S. Pat. No. 7,339,542 to Lalezari et al. discloses an ultra-broadband antenna system that combines an asymmetrical dipole element and a biconical dipole element to form a monopole. The asymmetrical dipole element includes upper and lower asymmetrical dipole elements. The antenna system also includes a plastic expander ring coupled to the lower asymmetrical dipole element. The expander ring is also coupled to a canister sub-assembly. A choke sub-assembly is provided within the canister sub-assembly.

### SUMMARY OF THE INVENTION

In view of the foregoing background, it is therefore an object of the present invention to provide an antenna assembly having reduced size and lobe formation across a range of desired operating frequencies.

This and other objects, features, and advantages in accordance with the present invention are provided by an antenna assembly that includes first and second adjacent antenna elements each including a conical antenna body having a base and an apex opposite the base. The first and second adjacent antenna elements also includes a cylindrical antenna body extending from the base of the conical antenna body, and a choke assembly including a choke shaft having a proximal end coupled to the conical antenna body and a distal end opposite the proximal end. The choke assembly includes at least one choke member carried by the distal end of the choke shaft in longitudinally spaced relation from an opposing end of the cylindrical antenna body to define at least one choke slot. Each of the first and second conical antenna bodies are aligned along a common longitudinal axis with respective apexes in opposing relation to define a symmetrical biconical dipole antenna. Accordingly, the antenna assembly has a reduced size and lobe formation across a range of desired operating frequencies.

The proximal end of the choke shaft and the opposing portions of the conical antenna body may define an adjustable length connection to permit longitudinal adjustment of the at least one choke slot. The adjustable length connection may include a threaded connection.

The choke shaft of the first antenna element may include a hollow choke shaft defining a first antenna feed point. The antenna assembly may further include a conductor extending through the hollow choke shaft and coupled to the conical antenna body of the second antenna element to define a second antenna feed point.

In another embodiment, the antenna assembly may include a coaxial cable extending through the hollow choke shaft. The coaxial cable may include an inner conductor coupled to the conical antenna body of the second antenna element, for example. The coaxial cable may also include an outer conductor surrounding the inner conductor and coupled to the cylindrical antenna body of the first antenna element.

The conical antenna body of the first antenna element may have an opening at the apex thereof. The antenna assembly may further include a tubular dielectric spacer positioned in the opening and receiving the inner conductor of the coaxial cable, for example. The inner conductor is coupled to the conical antenna body of the second antenna element.

The cylindrical antenna body may also include a mesh electrical conductor. In some embodiments, the cylindrical antenna body may also include a continuous electrical conductor. The antenna assembly may further include a dielectric cylindrical body surrounding the pair of first and second adjacent antenna elements, for example.

A method aspect is directed to a method of making an antenna assembly. The method includes forming first and second adjacent antenna elements. The first and second antenna elements include a conical antenna body having a base and an apex opposite the base, a cylindrical antenna body extending from the base of the conical antenna body, and a choke assembly. The choke assembly includes a choke shaft having a proximal end coupled to the conical antenna body and a distal end opposite the proximal end. The choke assembly also includes at least one choke member carried by the distal end of the choke shaft in longitudinally spaced relation from an opposing end of the cylindrical antenna body to define at least one choke slot. The method includes aligning each of the first and second conical antenna bodies along a common longitudinal axis with respective apexes in opposing relation to define a symmetrical biconical dipole antenna.

### BRIEF DESCRIPTION OF THE DRAWINGS

FIG. 1a is a schematic view of a biconical antenna in accordance with the prior art.

FIGS. 1b-1c are respective graphs of low and high frequency gain patterns of the biconical antenna of FIG. 1a.

FIG. 2a is a schematic view of a truncated biconical antenna in accordance with the prior art.

FIGS. 2b-2c are respective graphs of low and high frequency gain patterns of the truncated biconical antenna of FIG. 2a.

FIG. 3 is a perspective view of an antenna assembly in accordance with the present invention.

FIG. 4 is a partial exploded view of the antenna of FIG. 3.

FIG. 5 is a cross-sectional view of a portion of the first and second conical antenna bodies of the antenna of FIG. 3 including a dielectric spacer.

FIG. 6 is a perspective view of the antenna assembly of FIG. 3 including a dielectric cylindrical body.

FIGS. 7a-7b are respective graphs of low and high frequency gain patterns of the antenna of FIG. 3.

FIG. 8 is a graph of measured return loss versus simulated return loss for the antenna of FIG. 3.

FIG. 9 is a perspective view of another embodiment of an antenna assembly in accordance with the present invention.

FIG. 10 is a perspective view of another embodiment of an antenna assembly in accordance with the present invention.

FIG. 11 is a perspective view of another embodiment of an antenna assembly in accordance with the present invention.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime notation is used to indicate similar elements in alternative embodiments.

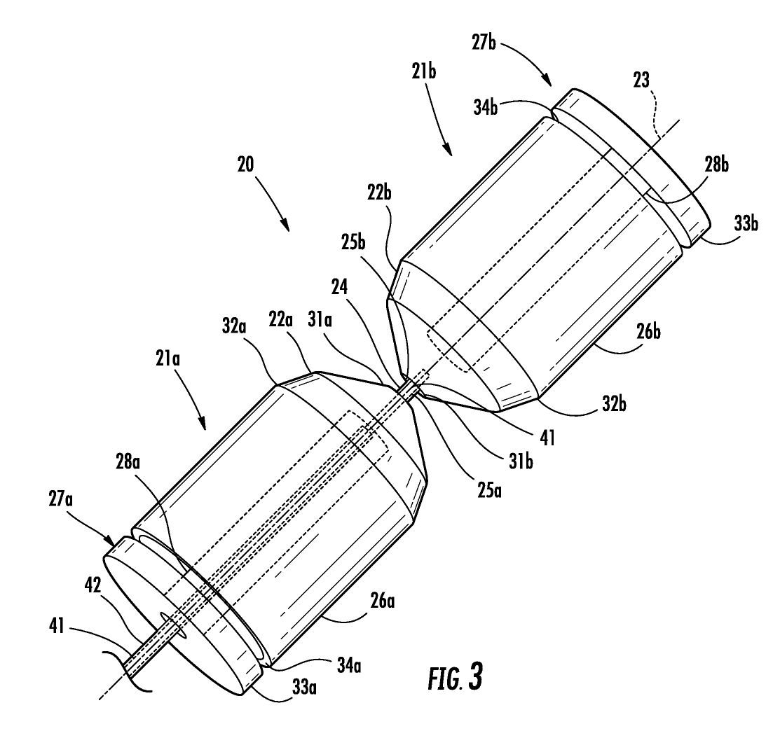

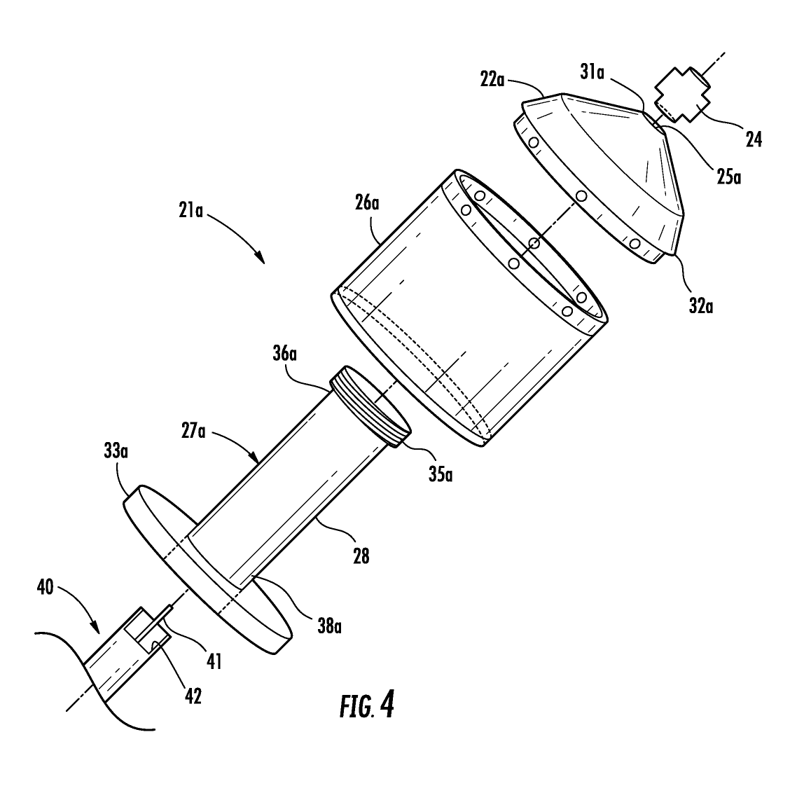

Referring initially to FIGS. 3-5, an antenna assembly 20 includes first and second adjacent antenna elements 21a, 21b. Each of the first and second adjacent antenna elements 21a, 21b illustratively includes a conical antenna body 22a, 22b having a base 32a, 32b and an apex 31a, 31b opposite the base.

Each conical antenna body 22a, 22b illustratively has two-stages defining a step therebetween. As will be appreciated by those skilled in the art, the two-step conical antenna body 22a, 22b may be used to match a return loss. An approximation of a curve corresponding to a desired return loss at a desired frequency may be accomplished by adding additional stages to form the conical antenna body 22a, 22b. The two-stage conical antenna body 22a, 22b provides improved return loss performance over a single-plane conical antenna body. Of course, each conical antenna body 22a, 22b may be formed having a single stage or more than two stages. Moreover, the stages may be formed to define any shape, but an overall spherical shape of the conical antenna body is less desired, for example, for wideband frequency operation.

An increase in the size or diameter of each conical antenna body 22a, 22b advantageously increases performance. For example, an increase in the diameter of the base 32a, 32b of the conical antenna body 22a, 22b corresponds to an increase in frequency bandwidth. Thus, the diameter of each conical antenna body 22a, 22b may be determined based upon a compromise of desired size and desired performance.

Each of the first and second adjacent antenna elements 21a, 21b also includes a cylindrical antenna body 26a, 26b extending from the base 32a, 32b of the conical antenna body 22a, 22b. The cylindrical antenna body 26a, 26b illustratively is a continuous electrical conductor.

Each of the first and second adjacent antenna elements 21a, 21b also includes a choke assembly 27a, 27b that illustratively includes a choke shaft 28a, 28b. The choke shaft 28a, 28b has a proximal end 36a, 36b that is coupled to the conical antenna body 22a, 22b. The choke shaft 28a, 28b also includes a distal end 38a, 38b opposite the proximal end 36a, 36b. The choke assembly 27a, 27b also includes a choke member 33a, 33b carried by the distal end 38a, 38b of the choke shaft 28a, 28b in longitudinally spaced relation from an opposing end of the cylindrical antenna body 26a, 26b to define the choke slot 34a, 34b.

The proximal end 36a, 36b of the choke shaft 28a, 28b and the opposing portions of the conical antenna body 22a, 22b cooperate to define an adjustable length connection to permit adjustment of the choke slot 34a, 34b. Illustratively, the adjustable length connection includes a threaded connection 35a, 35b so that the choke slot 34a, 34b may be adjusted by threading the choke shaft 28a, 28b in or out of the corresponding threaded portion 35a, 35b of the conical antenna body 27a, 27b. For example, the distance of the choke slot 34a, 34b may be adjusted so that a length of the overall first and/or second antenna elements 21a, 21b correspond to a half-wavelength of a desired operating frequency. Other types of adjustable connections may be used. In some embodiments (not shown), the distance of the choke slot 34a, 34b may be fixed.

The longitudinally spaced distance between the choke member 33a, 33b from the opposing end of the cylindrical antenna body 26a, 26b advantageously affects the performance of the antenna. For example, the longitudinally spaced distance between the choke member 33a, 33b from the opposing end of the cylindrical antenna body 26a, 26b affects the radiation pattern and/or return loss by altering the location of lobes in the gain pattern.

Additional choke members (not shown) may be included in the choke assembly 27a, 27b to define a plurality of choke slots 34a, 34b. Thus additional lobe control may be provided. Reduction of “lobing” at other or additional frequencies may be accomplished by adjusting the length of the choke shaft 28a, 28b, and thus shifting the location of the choke slot 34a, 34b relative to the center of the antenna assembly 20. Moreover, the length of the choke shaft 28a, 28b may change based upon a desired operating frequency, bandwidth, return loss, and lobe location, for example. Other factors may be considered in determining the number and location of choke members and thus choke slots.

The conical antenna body 22a of the first antenna element 21a has an opening 25a at the apex 31a thereof. A tubular dielectric spacer 24 is positioned in the opening 25a for receiving an inner conductor 41 of a coaxial cable 40, or other conductor, for example. The conical antenna body 22b of the second antenna element 21b may be similarly configured with an opening 25b at an apex 31b thereof, and may have a connector (not shown) therein for receiving the inner conductor 41.

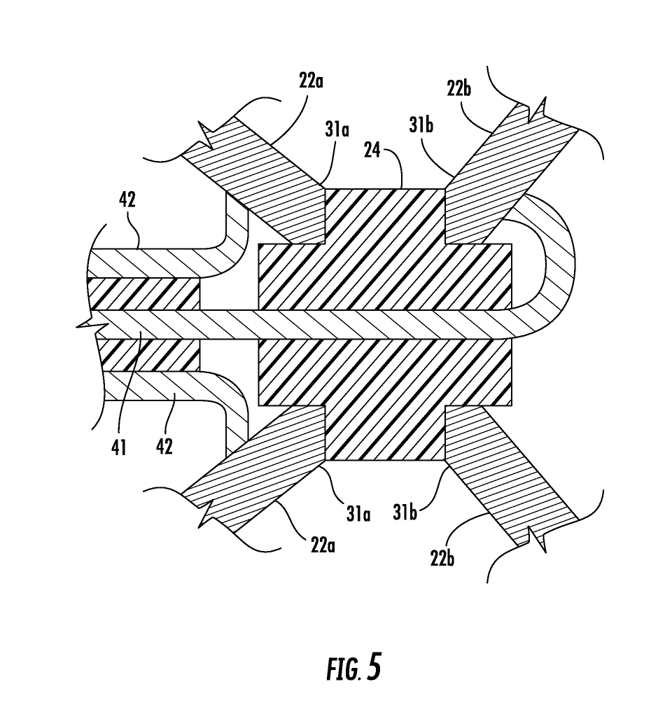

The choke shaft 28a of the first antenna element 21a is hollow. The coaxial cable 40 extends through the hollow choke shaft 28a. The inner conductor 41 is coupled to the conical antenna body 22b of the second antenna element 21b (FIG. 5). The inner conductor 41 passes through the tubular dielectric spacer 24 in the apex 31a of the first antenna element 21a to couple with the conical antenna body 22b of the second antenna element 21b. A coaxial cable connector (not shown) may be included in the conical antenna body 22b of the second antenna element 21b for coupling to the center conductor 41.

The coaxial cable 40 also includes an outer conductor 42 surrounding the inner conductor 41 and coupled to the cylindrical antenna body 26a of the first antenna element 21a (FIG. 5). Other types of conductors may extend through the hollow choke shaft, for example a rigid conductor, which may be formed as part of the choke assembly. Additionally, the second choke shaft 28b may also be hollow, thus reducing manufacturing costs by reducing the amount of material used and the machining of two different choke assemblies. In some embodiments, the choke shafts 28a, 28b may not be hollow.

Each of the first and second conical antenna bodies 22a, 22b are illustratively aligned along a common longitudinal axis 23 with respective apexes 31a, 31b in opposing relation to define a symmetrical biconical dipole antenna.

The overall height of the first and second adjacent antenna elements 21a, 21b is typically determined by the desired operating frequency. The height of the antenna may also be determined based upon a size limitation of a device housing, for example.

Additionally, as a desired frequency increases across a desired bandwidth, the choke assembly 27a, 27b acts as an inductor at relatively lower frequencies so that the radio frequency (RF) signal “sees” the entire height of the first and second antenna elements, i.e. the conical antenna bodies 22a, 22b, the cylindrical antenna bodies 26a, 26b, and the choke members 33a, 33b. In contrast, at relatively high frequencies, the RF signal “sees” the smaller portions of the antenna, i.e. the conical antenna bodies 22a, 22b and the cylindrical antenna bodies 26a, 26b. This advantageously helps to shape and control the gain pattern or lobes in the gain pattern for a desired application, for example ultra-wideband communications.

The antenna assembly 20 may further include a balun (not shown). A balun may be desired based upon how the coaxial cable 40 or conductor is attached to the conical antenna body 22a, 22b. The balun may advantageously balance the RF signals in each of the first and second adjacent antenna elements 21a, 21b.

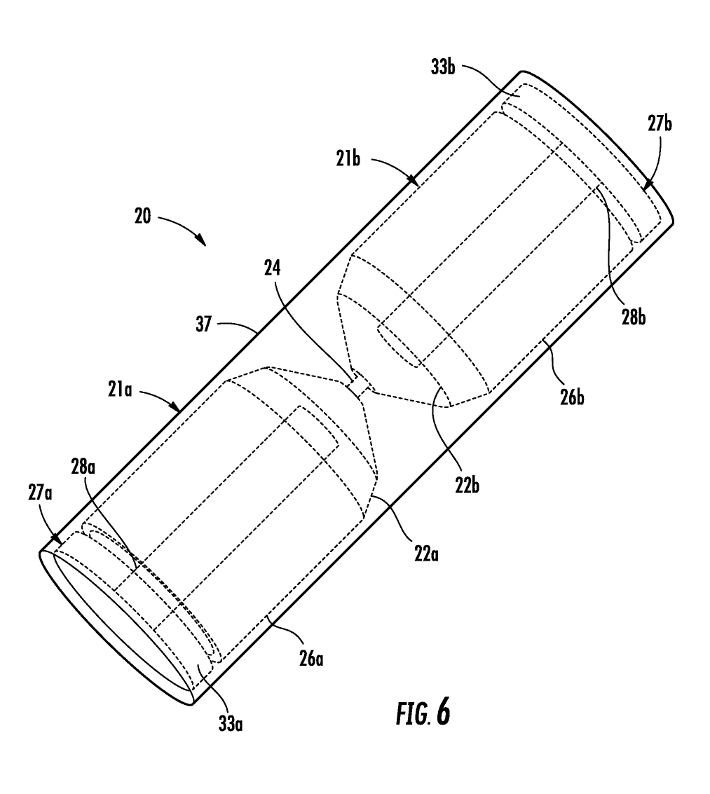

Referring now to FIG. 6, the antenna assembly 20 further includes a dielectric cylindrical body 37 surrounding the pair of first and second adjacent antenna elements. The dielectric cylindrical body 37 may provide additional rigidity to the antenna assembly 20 with reduced affect on the antenna assembly performance. The dielectric cylindrical body 37 may be used in any of the embodiments described herein.

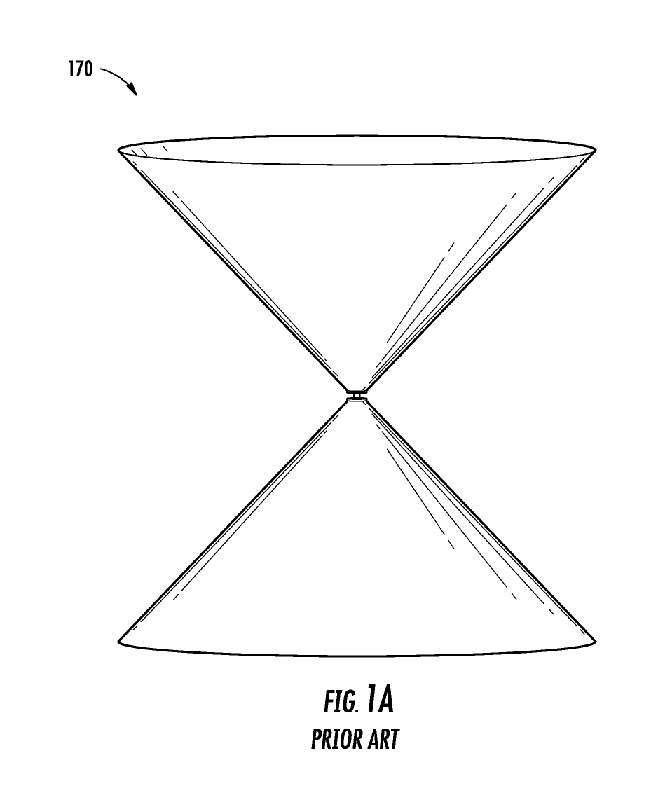

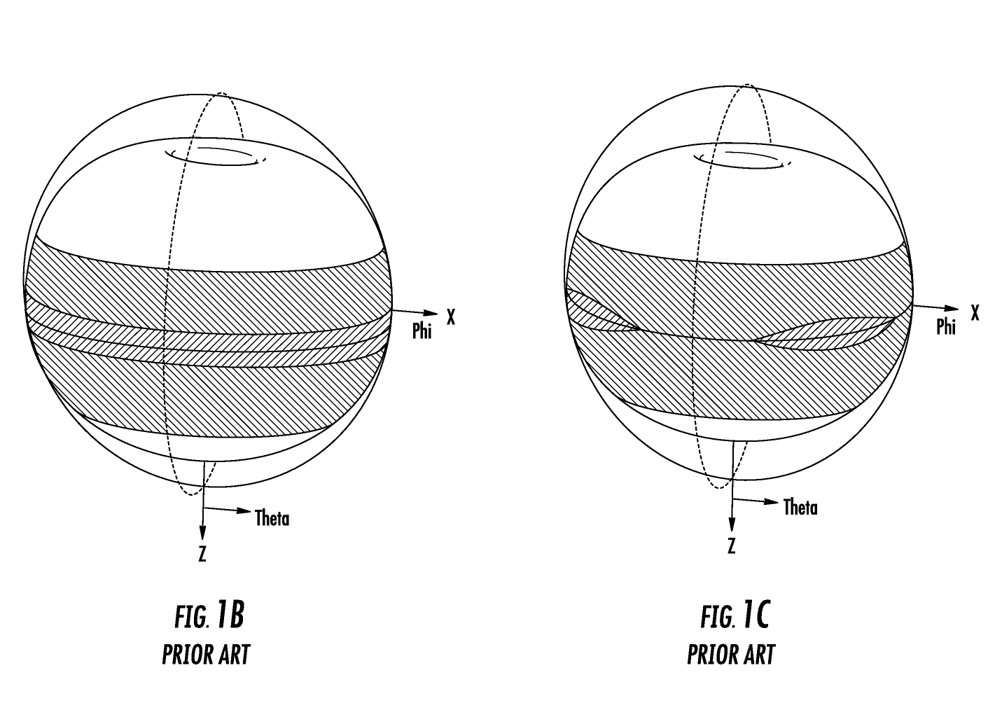

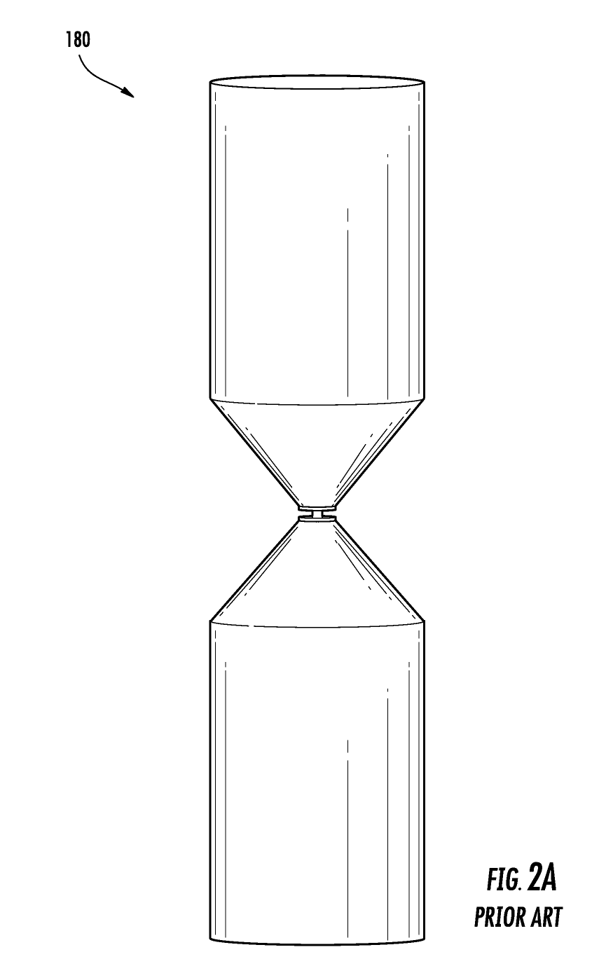

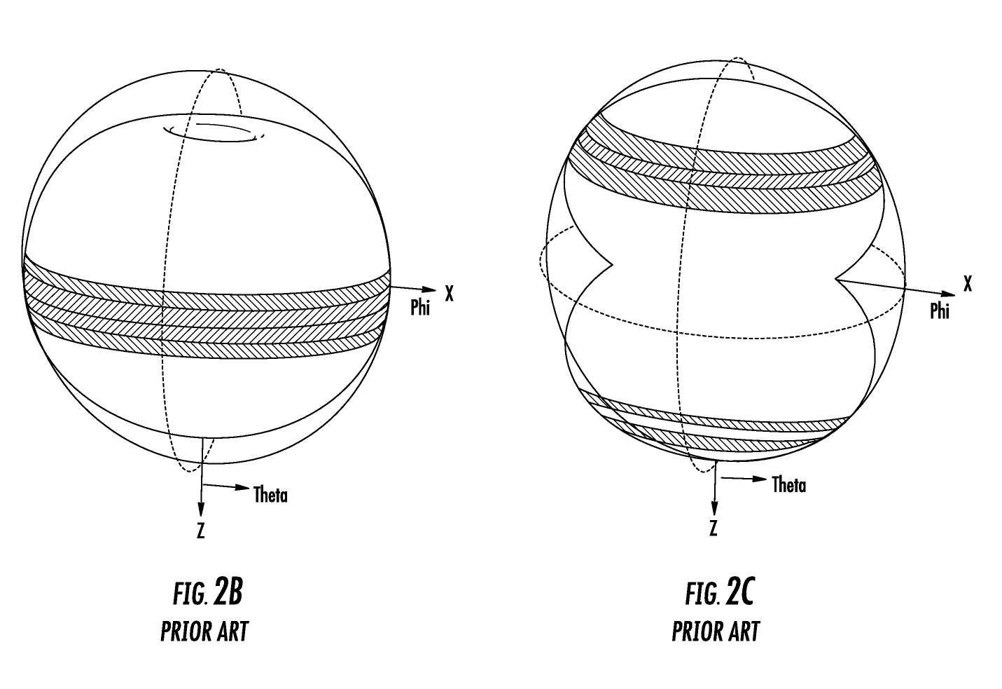

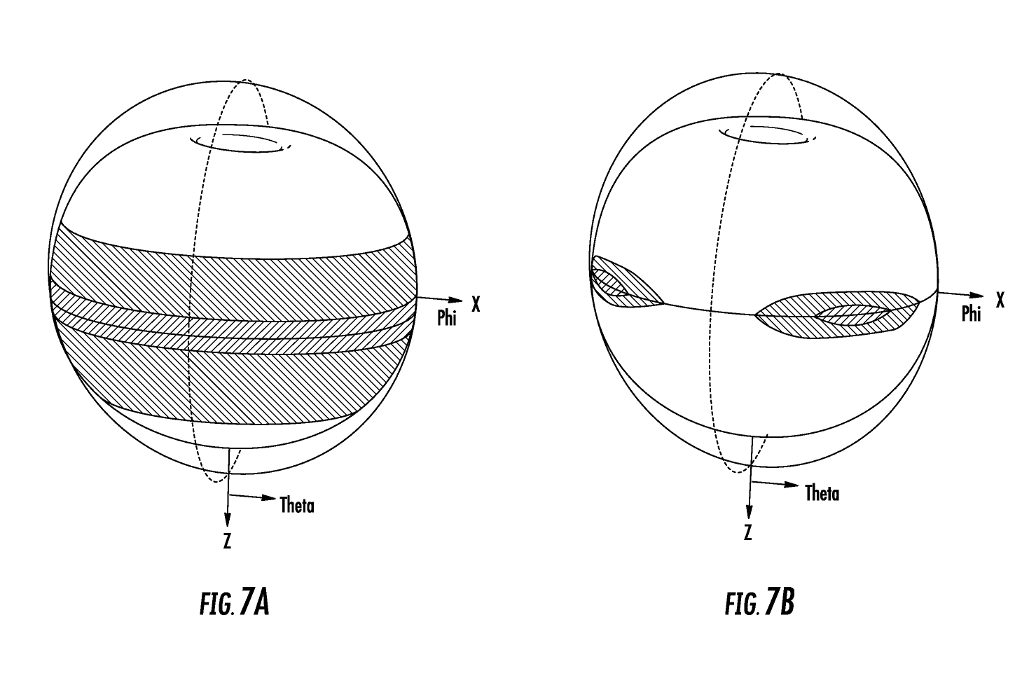

Referring now to the graphs in FIGS. 7a and 7b, the choke slot 34a, 34b advantageously reduces “lobing” at certain frequencies, thus reducing nulls in the radiation pattern of the antenna assembly 20 that are located on the horizon, for example. The gain patterns in the graphs illustratively have improved performance over the prior art antennas, whose gain patterns are illustrated in the graphs of FIGS. 1b, 1c, 2b, and 2c.

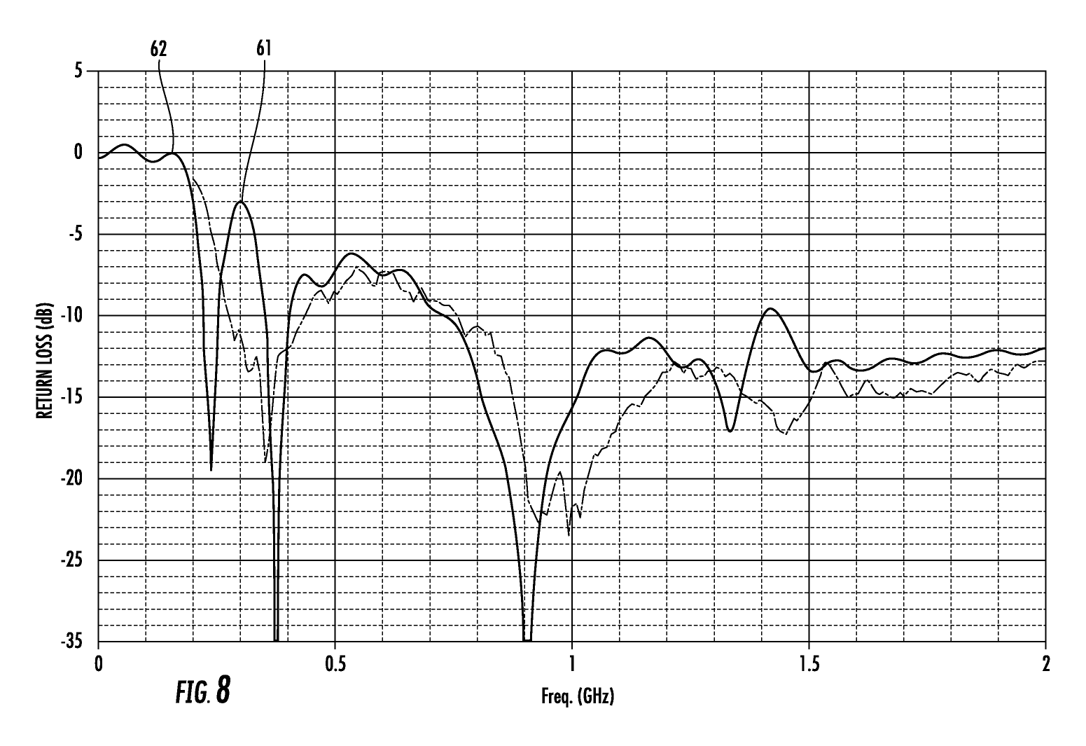

A antenna assembly was formed to have a height of 15.5 inches and a diameter of 4 inches. The antenna assembly exhibits operation from 225 MHz to 2 GHz with reduced or no nulls on the horizon, for example as illustrated in the graphs of FIGS. 7a and 7b. In contrast, a prior art antenna, without the choke slots, exhibited nulls between 800 and 900 MHz. Referring additionally to the graph of FIG. 8, measured return loss 61 versus simulated return loss 62 for the prototype antenna assembly is illustrated.

Accordingly, the antenna assembly 20 may be particularly advantageous in a frequency range of about 225 MHz to 2 GHz, and in ultra-wideband applications, for example. Of course, the antenna assembly 20 may be used for other frequency ranges and other applications.

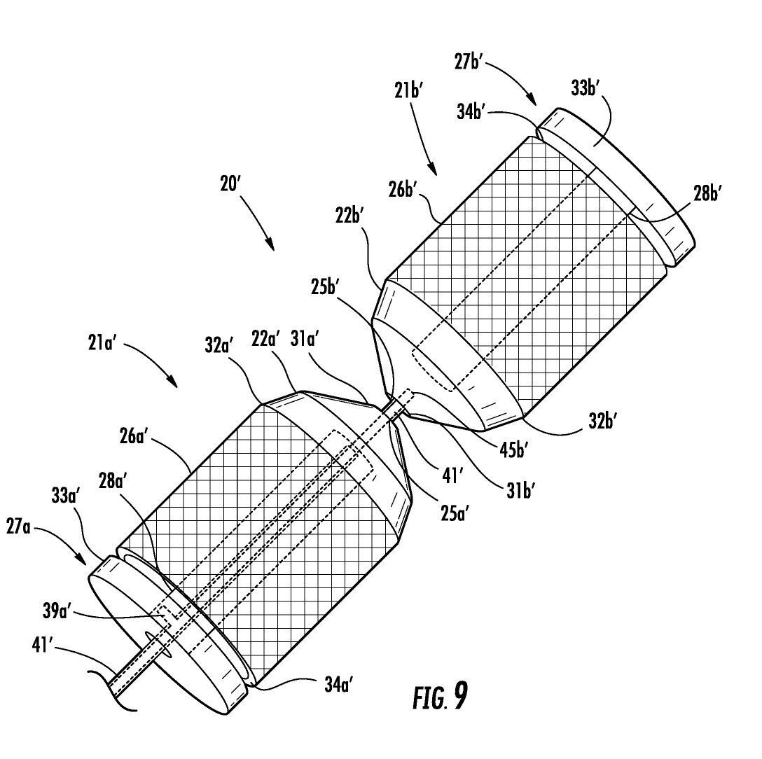

Referring now to FIG. 9, the illustrated embodiment of the cylindrical antenna body 26a′, 26b′ is a mesh electrical conductor. If openings in the mesh electrical conductor 26a′, 26b′ are small enough, effects of the cylindrical antenna body, for example, on gain and return loss, may be reduced. Other portions of the antenna assembly 20′ may include mesh, for example to reduce overall weight.

Additionally, the hollow choke shaft 28a′ of the first antenna element 21a′ defines a first antenna feed point 39a′. A conductor 41′ extends through the hollow choke shaft 28a′ and is coupled to the conical antenna body 22b′ of the second antenna element 21b′ to define a second antenna feed point 45b′. In other words, this arrangement is an alternative to the coaxial cable feed described above.

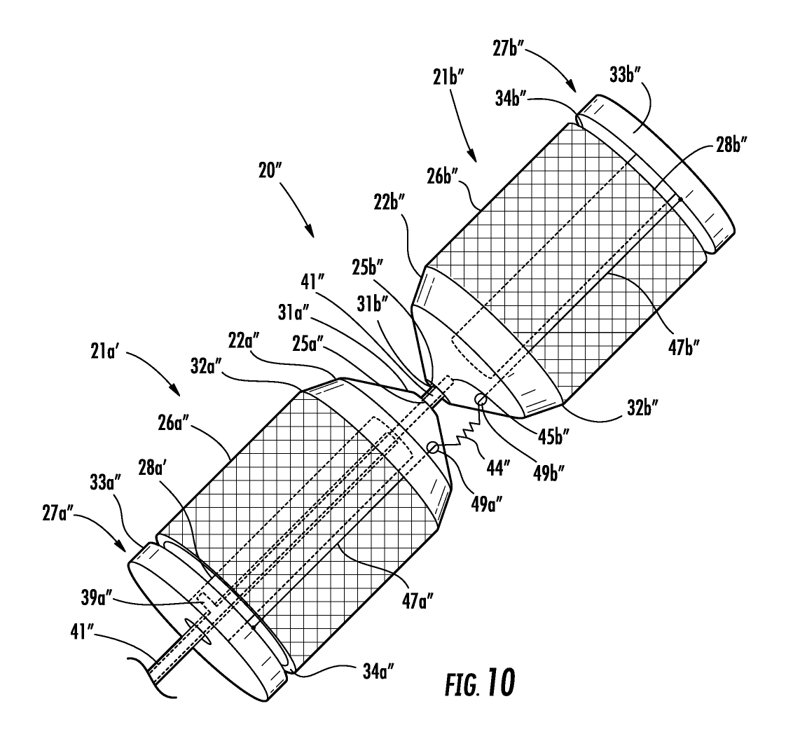

Referring now to FIG. 10, the illustrated embodiment of the antenna assembly 20″ extends the usable frequency range of the antenna assembly 20 to relatively low frequencies that may approach DC, for example. The antenna assembly 20″ advantageously trades increased VSWR bandwidth below cutoff for a reduction in realized gain above cutoff, such as for when VSWR bandwidth requirements exceed fundamental limitations of relative size and 100% radiation efficiency.

A resistor 44″, which may be a non-inductive resistor, is connected to the distal points of the antenna assembly 20″ by insulated conductive wires 47a″, 47b″. The insulated conductive wires 47a″, 47b″ enter and exit the antenna assembly 20″ through respective openings 49a″, 49b″ in each of the conical antenna bodies 22a″, 22b″. The resistor 44″ may be between about 50 to 200 Ohms, however, 50 Ohms may be preferential for many applications. A higher resistance value may provide a lower VSWR near cutoff, while 50 Ohms may provide a lower VSWR near DC.

For example, when the resistor 44″ is 100 Ohms, the gain may be reduced by about 2 dB above the antenna's lower cutoff frequency in exchange for lower VSWR below cutoff. Antennas, including conical half-elements may be high pass in nature, as they may exhibit relatively low VSWR at most frequencies above a lower threshold known as the cutoff frequency. The conductive wires 47a″, 47b″ advantageously provide an internal electrical fold connection for the resistor 44″.

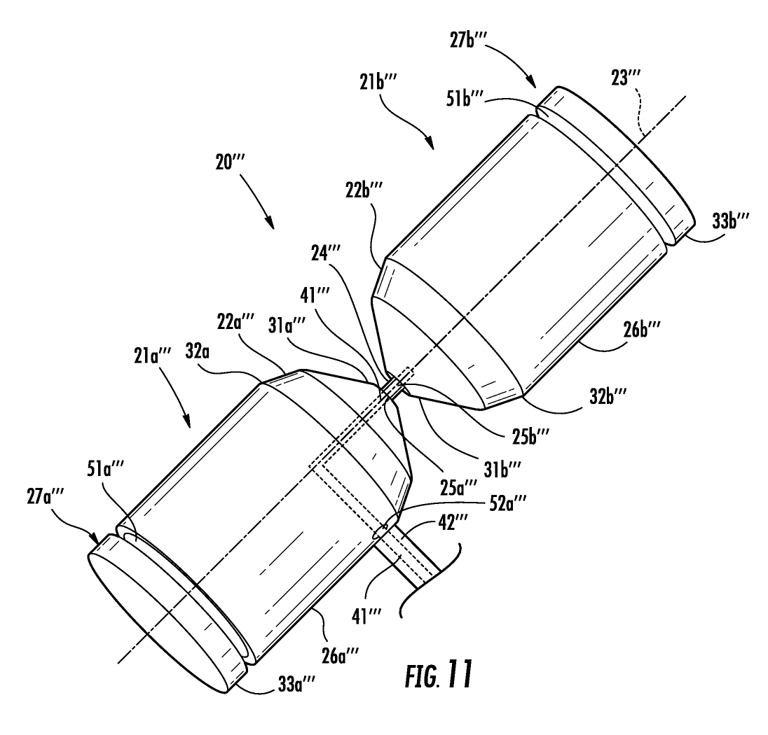

Referring now to FIG. 11, the illustrated embodiment of the of the antenna assembly 20′″ includes a choke assembly 27a′″, 27b′″ that includes a dielectric spacer 51a′″, 51b′″ positioned between the cylindrical antenna body 26a′″, 26b′″ and the choke member 33a′″, 33b′″. In other words, the choke member 33a′″, 33b′″ is longitudinally spaced from the end of the cylindrical antenna body opposing the conical antenna body 22a′″, 22b′″ to define a choke slot. The dielectric spacer 51a′″, 51b′″ is positioned within the choke slot. The dielectric spacer 51a′″, 51b′″ may be a polytetrafluoroethylene spacer, for example, a Teflon™ spacer as Teflon™ has a dielectric constant that is near the dielectric constant of air.

Additionally, the choke member 31a′″, 31b′″ may not include an opening therein. Instead, one of the cylindrical antenna bodies 26a′″, 26b′″ may include an opening 52a′″ adjacent the respective conical antenna body 22a′″, 22b′″ to allow the inner conductor 41′″ of the coaxial cable 40′″ to pass through and extend to the opening 25a′″. In some embodiments, except for the opening 52a′″, the cylindrical antenna bodies 26a′″, 26b′″ may be solid.

A method aspect is directed to a method of making an antenna assembly 20. The method includes forming first and second adjacent antenna elements 21a, 21b. The first and second antenna elements 21a, 21b include a conical antenna body 22a, 22b having a base 32a, 32b and an apex 31a, 31b opposite the base, a cylindrical antenna body 26a, 26b extending from the base of the conical antenna body, and a choke assembly 27a, 27b. The choke assembly 27a, 27b includes a choke shaft 28a, 28b having a proximal end 36a, 36b coupled to the conical antenna body 22a, 22b and a distal end 38a, 38b opposite the proximal end. The choke assembly 27a, 27b also includes at least one choke member 33a, 33b carried by the distal end 38a, 38b of the choke shaft 28a, 28b in longitudinally spaced relation from an opposing end of the cylindrical antenna body 26a, 26b to define at least one choke slot 34a, 34b. The method further includes aligning each of the first and second conical antenna bodies 22a, 22b along a common longitudinal axis 23 with respective apexes 31a, 31b in opposing relation to define a symmetrical biconical dipole antenna.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. An antenna assembly comprising:
first and second adjacent antenna elements each comprising
a conical antenna body having a base and an apex opposite the base,
a cylindrical antenna body extending from the base of said conical antenna body, and
a choke assembly comprising a mounting member and at least one choke member carried by said mounting member in longitudinally spaced relation from an opposing end of said cylindrical antenna body to define a choke slot;
each of said first and second conical antenna bodies aligned along a common longitudinal axis with respective apexes in opposing relation to define a symmetrical biconical dipole antenna.

2. The antenna assembly according to claim 1, wherein said mounting member comprises a choke shaft having a proximal end coupled to said conical antenna body and a distal end opposite the proximal end, and wherein said at least one choke member is carried by the distal end of said choke shaft.

3. The antenna assembly according to claim 1 wherein said mounting member comprises a dielectric spacer.

4. The antenna assembly according to claim 2, wherein the proximal end of said choke shaft and opposing portions of said conical antenna body define an adjustable length connection to permit longitudinal adjustment of the choke slot.

5. The antenna assembly according to claim 4, wherein the adjustable length connection comprises a threaded connection.

6. The antenna assembly according to claim 2, wherein said choke shaft of said first antenna element comprises a hollow choke shaft defining a first antenna feed point; and further comprising a conductor extending through said hollow choke shaft and coupled to said conical antenna body of said second antenna element to define a second antenna feed point.

7. The antenna assembly according to claim 2, wherein said choke shaft of said first antenna element comprises a hollow choke shaft; and further comprising a coaxial cable extending through said hollow choke shaft;
and wherein said coaxial cable comprises an inner conductor coupled to said conical antenna body of said second antenna element, and an outer conductor surrounding said inner conductor and coupled to said cylindrical antenna body of said first antenna element.

8. The antenna assembly according to claim 7, wherein said conical antenna body of said first antenna element has an opening at the apex thereof; and further comprising a tubular dielectric spacer positioned in the opening and receiving the inner conductor of said coaxial cable.

9. The antenna assembly according to claim 1, wherein said cylindrical antenna body comprises a mesh electrical conductor.

10. The antenna assembly according to claim 1, wherein said cylindrical antenna body comprises a continuous electrical conductor.

11. The antenna assembly according to claim 1, further comprising a dielectric cylindrical body surrounding said pair of first and second adjacent antenna elements.

12. The antenna assembly according to claim 1, further comprising a resistor coupled to said first and second at least one choke members.

13. An antenna assembly comprising:
first and second adjacent antenna elements each comprising
a conical antenna body having a base and an apex opposite the base,
a cylindrical mesh electrical conductor extending from the base of said conical antenna body, and
a choke assembly comprising a choke shaft having a proximal end coupled to said conical antenna body and a distal end opposite the proximal end, and at least one choke member carried by the distal end of said choke shaft in longitudinally spaced relation from an opposing end of said cylindrical mesh electrical conductor to define a choke slot, the proximal end of said choke shaft and opposing portions of said conical antenna body defining an adjustable length connection to permit longitudinal adjustment of the choke slot;
each of said first and second conical antenna bodies aligned along a common longitudinal axis with respective apexes in opposing relation to define a symmetrical biconical dipole antenna.

14. The antenna assembly according to claim 13, wherein the adjustable length connection comprises a threaded connection.

15. The antenna assembly according to claim 13, wherein said choke shaft of said first antenna element comprises a hollow choke shaft defining a first antenna feed point; and further comprising a conductor extending through said hollow choke shaft and coupled to said conical antenna body of said second antenna element to define a second antenna feed point.

16. The antenna assembly according to claim 13, wherein said choke shaft of said first antenna element comprises a hollow choke shaft; and further comprising a coaxial cable extending through said hollow choke shaft; and wherein said coaxial cable comprises an inner conductor coupled to said conical antenna body of said second antenna element, and an outer conductor surrounding said inner conductor and coupled to said cylindrical antenna body of said first antenna element.

17. The antenna assembly according to claim 16, wherein said conical antenna body of said first antenna element has an opening at the apex thereof; and further comprising a tubular dielectric spacer positioned in the opening and receiving the inner conductor of said coaxial cable.

18. The antenna assembly according to claim 13, further comprising a dielectric cylindrical body surrounding said pair of first and second adjacent antenna elements.

19. A method of making antenna assembly comprising:
forming first and second adjacent antenna elements, comprising
a conical antenna body having a base and an apex opposite the base,
a cylindrical antenna body extending from the base of the conical antenna body, and
a choke assembly comprising a mounting member and at least one choke member carried by said mounting member in longitudinally spaced relation from an opposing end of the cylindrical antenna body to define a choke slot; and
aligning each of the first and second conical antenna bodies along a common longitudinal axis with respective apexes in opposing relation to define a symmetrical biconical dipole antenna.

20. The method according to claim 19, wherein forming the first and second adjacent antenna elements to include the choke assembly including the mounting member comprises forming the first and second adjacent antenna elements to include the choke assembly including a choke shaft having a proximal end coupled to the conical antenna body and a distal end opposite the proximal end, and wherein the at least one choke member is carried by the distal end of the choke shaft.

21. The method according to claim 19, wherein forming the first and second adjacent antenna elements to include the mounting member comprises forming the first and second adjacent antenna elements to include a dielectric spacer.

22. The method according to claim 20, wherein forming the first and second adjacent antenna elements comprises forming the first and second adjacent antenna elements so that the proximal end of the choke shaft and opposing portions of the conical antenna body define an adjustable length connection to permit longitudinal adjustment of the at least one choke slot.

23. The method according to claim 20, wherein forming the first and second adjacent antenna elements comprises forming the first and second antenna elements so that the choke shaft of the first antenna element comprises a hollow choke shaft; and further comprising coupling a coaxial cable to extend through the hollow choke shaft; and wherein coupling the coaxial cable comprises coupling an inner conductor to the conical antenna body of second antenna element, and coupling an outer conductor surrounding the inner conductor to the cylindrical antenna body of the first antenna element.

24. The method according to claim 23, further comprising positioning a tubular dielectric spacer in an opening at the apex of the conical antenna body of the first antenna element and receiving the inner conductor of the coaxial cable.

25. The method according to claim 19, wherein forming the first and second adjacent antenna elements comprises forming the forming the first and second antenna elements so that the cylindrical antenna body comprises a mesh electrical conductor.

26. The method according to claim 19, wherein forming the first and second adjacent antenna elements comprises forming the first and second adjacent elements so that the cylindrical antenna body comprises a continuous electrical conductor.

27. The method according to claim 19, further comprising coupling a dielectric cylindrical body to surround the pair of first and second adjacent antenna elements.
